(19) United States
(12) Patent Application Publication
(10) Pub. No.: US 2018/0133723 A1
(43) Pub. Date: May 17, 2018

(54) INFLOW APPARATUS FOR A DECANTER CENTRIFUGE

(71) Applicant: Ferrum AG, Schafisheim (CH)

(72) Inventors: Mark NÄGELI, Othmarsingen (CH); Roger SALZMANN, Niedergosgen (CH); Marc ZUBLER, Rupperswil (CH); Manuel MATHYS, Kolliken (CH)

(21) Appl. No.: 15/799,300

(22) Filed: Oct. 31, 2017

(30) Foreign Application Priority Data
Nov. 15, 2016 (EP) 16198937.1

(51) Int. Cl. B04B 7/00; B04B 1/20; B04B 11/02

(52) U.S. Cl. CPC B04B 7/00; B04B 11/02; B04B 1/20

(57) ABSTRACT

An inflow apparatus includes an inlet opening for introducing a starting product into the inflow apparatus, at least one first outlet opening and one second outlet opening different from the first outlet opening for feeding the starting product from the inflow apparatus into the filling zone. The inflow apparatus additionally includes a connection device via which the inlet opening is in flow communication with the first outlet opening and with the second outlet opening. To ensure a homogeneous distribution of the starting product in the filling zone in the peripheral direction, the connection device includes a first passage and a second passage different from the first passage, with the first outlet opening being in flow communication with the inlet opening via the first passage and the second outlet opening being in flow communication with the inlet opening via the second passage.

### CROSS-REFERENCE TO RELATED APPLICATION

This application claims priority to European Application No. 16198937.1, filed Nov. 15, 2016, the contents of which are hereby incorporated herein by reference.

### BACKGROUND

### Field of the Invention

The invention relates to an inflow apparatus for a decanter centrifuge. The invention further relates to a centrifuge drum for a decanter centrifuge.

### Background of the Invention

Such inflow apparatus are used in decanter centrifuges. Decanter centrifuges in this respect comprise a rotating centrifuge drum and a conveying element that co-rotates with the centrifuge drum and that is located within the centrifuge drum. The conveying element is a helical hollow shaft and extends at least partly over the length of the centrifuge drum. The starting product is introduced into the hollow shaft in the form of a suspension via an infeed pipe of the decanter centrifuge and is dispensed to the centrifuge drum via openings at the peripheral surface of the hollow shaft in a filling zone and is centrifuged. The centrifuge drum has a closed jacket surface on which the solid portion in the centrifugal field is deposited to form a cake which is conveyed in an axial direction by the helical conveying element and which is expelled via an outlet apparatus.

An inflow apparatus is now arranged in the hollow shaft to introduce the starting product from the infeed pipe into the hollow shaft. A known inflow apparatus in this respect comprises an inlet opening via which the starting product can be introduced into the inflow apparatus. In addition, the inflow apparatus comprises at least one first outlet opening and a second outlet opening different from the first outlet opening for feeding the starting product from the inflow apparatus into the filling zone. The inlet opening is in flow communication with the first outlet opening and the second outlet opening via a connection device.

Reference is made to FIG. 1 to explain this inflow apparatus in the following and the previously described prior art will be described in somewhat more detail with reference thereto. To distinguish the prior art from the present invention, the reference numerals that relate to features of known examples have been provided with a prime, whereas features of embodiments in accordance with the invention have been provided with reference numerals not having a prime.

FIG. 1 shows a sectional representation of a centrifuge drum 9′ of a decanter centrifuge (not shown) having a conveying element 10′ and a known inflow apparatus 1′.

In accordance with FIG. 1, the centrifuge drum 9′ is rotatably supported in the decanter centrifuge via bearing elements 11′. The co-rotating conveying element 10′ is likewise rotatably supported via bearing elements 11′ within the centrifuge drum 9′. The conveying element 10′ is designed as a helical hollow shaft and extends at least partly over the length of the centrifuge drum 9′. The starting product is introduced into the hollow shaft in the form of a suspension via an infeed pipe 12′ of the decanter centrifuge and is dispensed to the centrifuge drum 9′ via openings at the peripheral surface of the hollow shaft in a filling zone 13′ and is centrifuged. The centrifuge drum 9′ has a closed jacket surface on which the solid portion in the centrifugal field is deposited to form a cake which is conveyed in an axial direction by the helical conveying element 10′ and which is expelled via an outlet apparatus.

A known inflow apparatus 1′ is arranged in the hollow shaft to introduce the starting product from the infeed pipe 12′ into the hollow shaft. In accordance with FIG. 1, the known inflow apparatus 1′ here comprises an inlet opening 2′ via which the starting product is introduced into the inflow apparatus 1′. The inlet opening 2′ extends coaxially to a longitudinal axis 14′ of the inflow apparatus 1′. In addition, the inflow apparatus 1′ comprises a first outlet opening 301′ and a second outlet opening (not shown) different from the first outlet opening 301′ for feeding the starting product from the inflow apparatus 1′ into the filling zone 13′ of the decanter centrifuge. The first outlet opening 301′ and the second outlet opening are arranged radially to the longitudinal axis 14′. The inlet opening 2′ is in flow communication with the first outlet opening 301′ and the second outlet opening via a connection device 4′ of the inflow apparatus 1′. The connection device 4′ is configured in the form of a passage that conducts the starting product from the inlet opening 2′ to the first outlet opening 301′ and to the second outlet opening.

During the operation of the decanter centrifuge, the starting product is introduced from the infeed pipe 12′ of the decanter centrifuge via the inlet opening 2′ into the inflow apparatus 1′. The starting product collects in the connection device 4′ and is then fed via the first outlet opening 301′ and the second outlet opening into the filling zone 13′ due to the rotation of the inflow apparatus 1′. The starting product is accordingly deflected from an axial direction into a radial direction in the connection device 4′.

### SUMMARY

A substantial disadvantage of the described inflow apparatus comprises the starting product being fed inhomogeneously into the filling zone of the decanter centrifuge in the peripheral direction of the centrifuge drum. As a result, the starting product in the filling zone is dispensed to the centrifugal drum and is centrifuged unevenly. The cake deposited at the inner surface of the centrifuge drum thereby has a varying thickness in the peripheral direction of the centrifuge drum.

This has a negative effect on the conveying and expulsion of the cake in the centrifuge drum by the helical conveying element.

In addition, an imbalance arises at the rotating centrifuge drum due to the varying thickness of the cake. This results in additional vibrations of the centrifuge drum that have a negative effect on the support of the centrifuge drum and results in increased wear.

In addition, the starting product in the known inflow apparatus is exposed to increased turbulence, which is accompanied by additional flow losses and vibrations.

It is the object of the invention to provide an inflow apparatus for a decanter centrifuge by which the starting product can be fed into the filling zone of the decanter centrifuge in an optimized manner, in particular distributed homogeneously and evenly, in the peripheral direction of the centrifuge drum.

The subjects of the invention satisfying this object are characterized by the features described herein.

The advantageous of the embodiments of the invention are further described herein.

The invention thus relates to an inflow apparatus for feeding a starting product into a filling zone of a decanter centrifuge comprising an inlet opening for introducing the starting product into the inflow apparatus; at least one first outlet opening and a second outlet opening different from the first outlet opening for feeding the starting product from the inflow apparatus into the filling zone; and a connection device via which the inlet opening is in flow communication with the first outlet opening and the second outlet opening.

In accordance with the invention, the connection device comprises a first passage and a second passage different from the first passage, wherein the first outlet opening is in flow communication with the inlet opening via the first passage and the second outlet opening is in flow communication with the inlet opening via the second passage.

Within the framework of this invention the term “in flow communication” is to be understood such that the first passage and the second passage are configured such that the starting product flowing into the inflow apparatus can be distributed at least partly over the first outlet opening and over the second outlet opening independently of one another. For example, the first passage and/or the second passage can extend at least partly from the first outlet opening and/or from the second outlet opening up to the inlet opening. I.e. the first passage and/or the second passage can extend continuously and independently of one another from the first outlet opening and/or from the second outlet opening up to the inlet opening or the first passage and/or the second passage is/are configured as not continuous from the first outlet opening and/or from the second outlet opening up to the inlet opening. It is also possible that the first passage and/or the second passage is/are substantially in flow communication with the inlet opening via the respective other passage.

This is in contrast to the prior art where the connection device is no longer configured by a plurality of passages, but rather by a single passage, typically in the form of the inflow apparatus itself, that conducts the starting product from the inlet opening to the first outlet opening and to the second outlet opening. The starting product is hereby not selectively conducted to the first outlet opening and to the second outlet opening.

Within the framework of this invention, the first passage and the second passage can have different cross-sectional geometries. The cross-section of the first passage and of the second passage can thus, for example, be n-angular, circular or oval. It is also possible that the cross-sectional geometry of the first passage and/or of the second passage varies over the length of the respective passage.

Furthermore, within the framework of the invention, the inlet opening can extend coaxially to a longitudinal axis of the inflow apparatus. The first outlet opening and/or the second outlet opening can extend radially to the longitudinal axis. The first passage and/or the second passage can thus extend in a curved manner with respect to the longitudinal axis so that a targeted deflection of the starting product substantially takes place from an axial direction into a radial direction through the first passage and/or through the second passage. The first outlet opening and the second outlet opening can also be arranged offset along the longitudinal axis. The inlet opening, the first outlet opening and the second outlet opening can furthermore be disposed in different planes.

In addition, within the framework of the invention, the inflow apparatus can have, beside the first outlet opening and the second outlet opening, further outlet openings that are likewise in flow communication with the inlet opening via a separate passage. I.e. within the framework of the invention, the inflow apparatus can also have further passages beside the first passage and the second passage.

A substantial advantage of the inflow apparatus in accordance with the invention is that the starting product is fed into the filling zone of the decanter centrifuge in an optimized manner, in particular distributed homogeneously and evenly, in the peripheral direction of the centrifuge drum. As a result, the starting product in the filling zone is dispensed evenly to the centrifugal drum and is centrifuged. The cake deposited at the inner surface of the centrifuge drum thereby has a uniform thickness in the peripheral direction of the centrifuge drum.

This has a positive effect on the conveying and expulsion of the cake in the centrifuge drum by the helical conveying element.

In addition, due to the uniform thickness of the cake, an imbalance at the rotating centrifuge drum is prevented so that additional vibrations of the centrifuge drum can be avoided that have a negative effect on the support of the centrifuge drum and thus result in increased wear.

In addition, the starting product is exposed to less turbulence in the inflow apparatus in accordance with the invention, which has a positive effect on the flow losses and on the vibrations.

In an embodiment very important for practice, the first passage extends continuously from the first outlet opening up to the inlet opening and the second passage extends continuously from the second outlet opening up to the inlet opening. An improved conveying of the starting product in the inflow apparatus hereby takes place due to fewer losses.

Alternatively, the inflow apparatus can, however, also have a mixing chamber between the inlet opening and the first outlet opening and/or the second outlet opening and the first passage can extend continuously from the first outlet opening up to the mixing chamber and/or the second passage can extend continuously from the second outlet opening up to the mixing chamber. The starting product is thereby collected in the mixing chamber before it is conducted into the first passage and/or the second passage. An improved homogenization of the starting product in the inflow apparatus takes place due to this design of the inflow apparatus.

In a preferred embodiment, the cross-section surface of the first passage increases from the inlet opening to the first outlet opening and/or the cross-section surface of the second passage increases from the inlet opening to the second outlet opening. As a result, an improved distribution of the starting product is achieved in the filling zone and the flow losses in the inflow apparatus are reduced.

It has been found to be advantageous for the first passage to open into the first outlet opening at a predefinable angle and/or for the second passage to open into the second outlet opening at a predefinable angle so that the first passage and/or the second passage follows/follow a curve. A targeted feeding of the starting product into the filling zone of the decanter centrifuge is hereby ensured.

In an embodiment very important for practice the inflow apparatus additionally has a fastening element for fastening the inflow apparatus in the filling zone. A fixed or releasable attachment of the inflow apparatus to the hollow shaft in the filling zone is made possible via the fastening element.

The fastening element can preferably, but not necessarily, be arranged in the region of the inlet opening and/or at an end opposite the inlet opening. As a result, the manufacture of the inflow apparatus is simplified and the stiffness of the inflow apparatus is increased.

The fastening element can e.g. be formed as a disk. The attachment of the inflow apparatus in the filling zone is hereby further simplified.

It is furthermore of advantage for the fastening element to be connected to the first passage and/or to the second passage via a support element. The stiffness of the inflow apparatus is increased by means of the support element and the first passage and/or the second passage is/are stabilized.

It has also proved to be advantageous if the first passage and/or the second passage are surrounded at least in part by a stabilizing element. The stiffness of the inflow apparatus can also be increased by the stabilizing element and the first passage and/or the second passage can be stabilized. The first outlet opening and/or the second outlet opening can be integrated in the stabilizing element in this respect.

The stabilizing element can preferably, but not necessarily, be formed as a lattice. The weight of the inflow apparatus can hereby be reduced.

In an embodiment very important for practice, the inflow apparatus is manufactured by an additive process. As a result, the weight of the inflow apparatus can be substantially reduced. In addition, the additive process enables the manufacture of an inflow apparatus with passages of complex geometry. The inflow apparatus can also be manufactured inexpensively by means of he additive process.

The present invention further relates to a centrifuge drum for a decanter centrifuge having an inflow apparatus in accordance with the invention and to a decanter centrifuge having an inflow apparatus in accordance with the invention.

### BRIEF DESCRIPTION OF THE DRAWINGS

The invention will be explained in more detail hereinafter with reference to the drawings.

FIG. 1 is a sectional representation of a centrifuge drum with a conveying element and with an inflow apparatus known from the prior art;

FIG. 2A is a first embodiment of an inflow apparatus in accordance with the invention,

FIG. 2B is a sectional representation of the conveying element with an inflow apparatus in accordance with FIG. 2A;

FIG. 3 is a second embodiment of an inflow apparatus in accordance with the invention;

FIG. 4 is a third embodiment of an inflow apparatus in accordance with the invention;

FIG. 5 is a fourth embodiment of an inflow apparatus in accordance with the invention;

FIG. 6 is a fifth embodiment of an inflow apparatus in accordance with the invention; and

FIG. 7 is a sixth embodiment of an inflow apparatus in accordance with the invention.

### DETAILED DESCRIPTION OF THE EMBODIMENTS

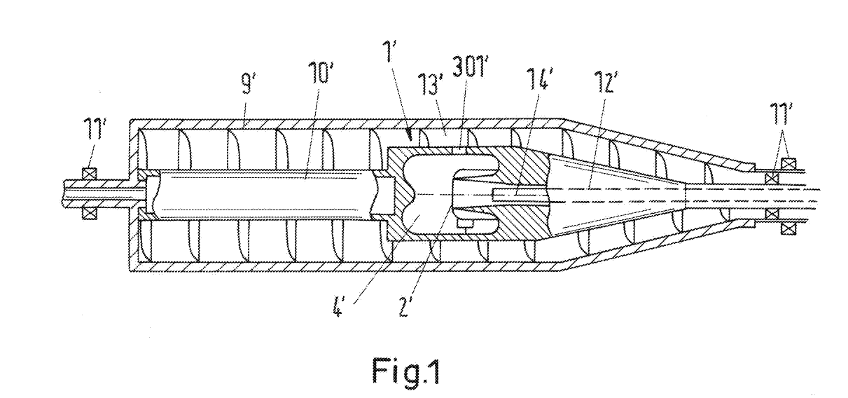

As already mentioned, FIG. 1 shows the prior art and has already been explained comprehensively in the introduction so that a further discussion will be dispensed with here.

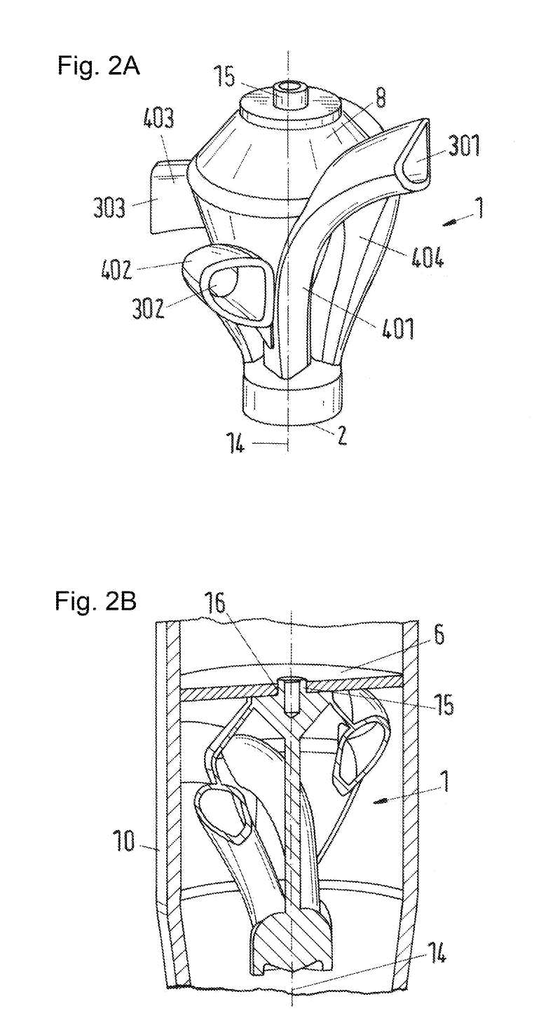

FIG. 2A shows a first embodiment of an inflow apparatus in accordance with the invention that will be marked in total by reference numeral 1 in the following. The reference numerals used in FIG. 2A to FIG. 7 do not have any prime in this respect since these Figures relate to embodiments of the present invention. As already mentioned above, only the reference numerals of FIG. 1 have a prime since it relates to the known prior art.

In accordance with FIG. 2A, the inflow apparatus 1 comprises an inlet opening 2, a first outlet opening 301, a second outlet opening 302, a third outlet opening 303, and a fourth outlet opening 304 (not shown in FIG. 2A). The outlet openings 301, 302, 303, 304 are configured differently from one another. As already mentioned with respect to FIG. 1, the inlet opening 2 serves for the feeding of a starting product into the filling zone of the decanter centrifuge and the outlet openings 301, 302, 303, 304 serve for the feeding of the starting product from the inflow apparatus into the filling zone. The inflow apparatus 1 furthermore comprises a connection device via which the inlet opening 2 is in flow communication with the first, second, third, and fourth outlet openings 301, 302, 303, 304. The connection device in this respect comprises a first passage 401, a second passage 402, a third passage 403, and a fourth passage 404. The passages 401, 402, 403, 404 are configured differently from one another. The first outlet opening 301 is in flow communication with the inlet opening 2 via the first passage 401; the second outlet opening 302 via the second passage; the third outlet opening 303 via the third passage 403; and the fourth outlet opening 304 via the fourth passage 404.

The first, second, third, and fourth passages 401, 402, 403, 404 each extend continuously from the first, second, third, and fourth outlet openings 301, 302, 303, 304 up to the inlet opening 2. The starting product flowing into the inflow apparatus is thus distributed over the first, second, third, and fourth outlet openings 301, 302, 303, 304 at the inlet opening 2. The first, second, third, and fourth passages 401, 402, 403, 404 are configured such that the cross-sectional surface of the respective passage increases from the inlet opening 2 to the first, second, third, and fourth outlet openings 301, 302, 303, 304. In addition, the inflow apparatus 1 comprises a stabilizing element 8 that partly surrounds the first, second, third, and fourth passages 401, 402, 403, 404. The inflow apparatus 1 additionally has a mount element in the form of a pin 15 at the other end of the inlet opening 2, said pin serving for mounting a fastening element 6 (FIG. 2B).

In the embodiment, the inlet opening 2 extends coaxially to a longitudinal axis 14 of the inflow apparatus 1 and the outlet opening 301, 302, 303, 304 extends radially to the longitudinal axis 14. The first, second, third, and fourth passages 401, 402, 403, 404 thus extend at a curve with respect to the longitudinal axis 14 so that a substantially targeted deflection of the starting product from an axial direction into a radial direction takes place through the first, second, third, and fourth passages 401, 402, 403, 404. In addition, in this embodiment, the outlet openings 301, 302, 303, 304 are arranged offset from one another along the longitudinal axis 14.

FIG. 2B shows a sectional representation of a conveying element 10 with the above-described inflow apparatus 1 in accordance with FIG. 2A. As can be seen from FIG. 2B, the inflow apparatus 1 is fastened to the inner surface of the conveying element 10 via a fastening element 6 that is formed as a disk. The connection between the inflow apparatus 1 and the fastening element 6 takes place via the pin 15 of the inflow apparatus 1 that cooperates with a bore 16 of the fastening element 6.

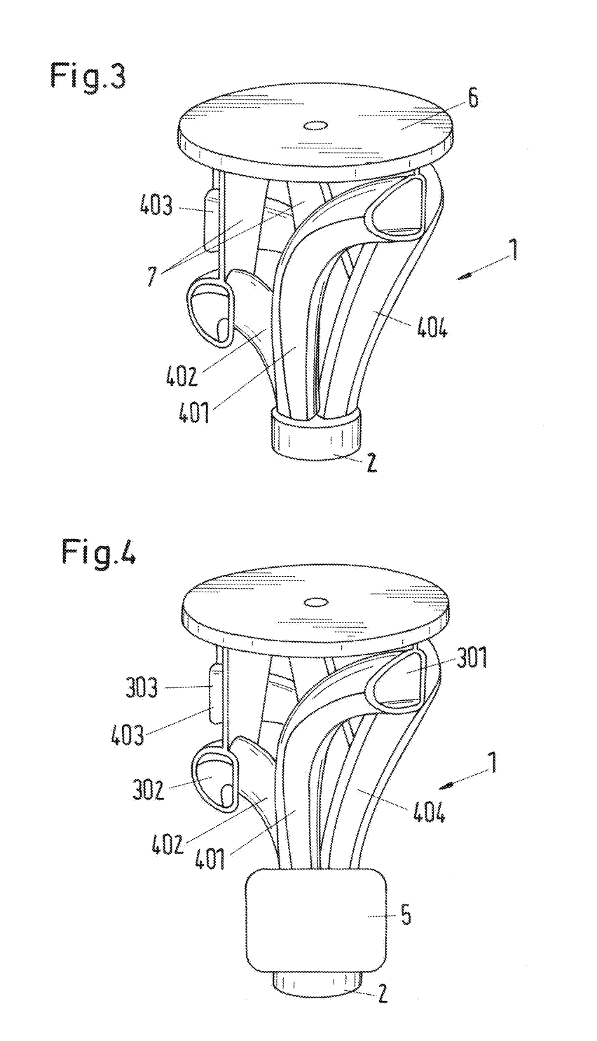

FIG. 3 shows a second embodiment of an inflow apparatus 1 in accordance with the invention. Unlike the embodiment in accordance with FIG. 2A, the inflow apparatus 1 does not have a stabilizing element that partly surrounds the first, second, third, and fourth passages 401, 402, 403, 404. The inflow apparatus 1 in contrast has a fastening element 6 at an end opposite the inlet opening 2. The fastening element 6 is formed as a disk and is connected to the passages via support elements 7.

A third embodiment of an inflow apparatus 1 in accordance with the invention is shown in FIG. 4. The inflow apparatus 1, unlike the inflow apparatus 1 in accordance with FIG. 3, has a mixing chamber 5. The mixing chamber 5 is arranged between the inlet opening 2 and the first, second, third, and fourth outlet openings 301, 302, 303, 304. The first, second, third, and fourth passages 401, 402, 403, 404 in this respect extend continuously from the respective outlet opening 301, 302, 303, 304 up to the mixing chamber 5. In this embodiment, the starting product is thus collected in the mixing chamber before it is conducted into the first, second, third, and fourth passages 401, 402, 403, 404.

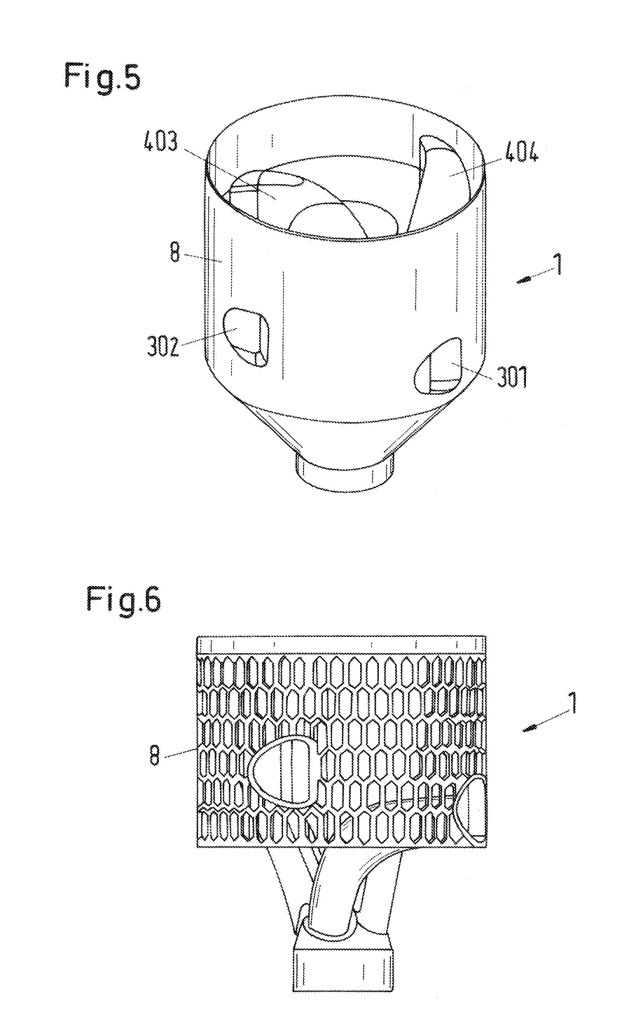

FIG. 5 shows a fourth embodiment of an inflow apparatus 1 in accordance with the invention. Unlike the embodiment in accordance with FIG. 2A, the inflow apparatus 1 has a stabilizing element 8 that partly surrounds the first, second, third, and fourth passages 401, 402, 403, 404. The first, second, third, and fourth outlet openings 301, 302, 303, 304 are integrated in the stabilizing element 8 in this respect. The stabilizing element 8 simultaneously serves as a fastening element for attaching the inflow apparatus 1 in the conveying element.

FIG. 6 shows a fifth embodiment of an inflow apparatus 1 in accordance with the invention. Unlike the embodiment in accordance with FIG. 5, the stabilizing element 8 is not formed as solid, but rather as a lattice. In addition, the stabilizing element 8 only extends over a part of the length of the inflow apparatus 1.

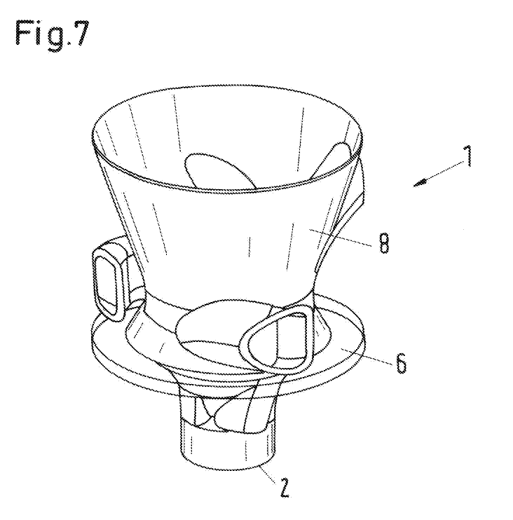

FIG. 7 shows a sixth embodiment of an inflow apparatus 1 in accordance with the invention. Unlike the embodiment in accordance with FIG. 2A, the inflow apparatus 1 additionally has a fastening element 6 that is formed as a disk and is arranged in the region of the inflow opening 2.

1. An inflow apparatus for feeding a starting product into a filling zone of a decanter centrifuge, comprising:
an inlet opening configured to introduce the starting product into the inflow apparatus;
at least one first outlet opening and a second outlet opening different from the first outlet opening, the at least one first outlet opening and the second outlet opening configured to feed the starting product from the inflow apparatus into the filling zone; and
a connection device via which the inlet opening is in flow communication with the first outlet opening and the second outlet opening,
the connection device including a first passage and a second passage different from the first passage, with the first outlet opening being in flow communication with the inlet opening via the first passage and the second outlet opening being in flow communication with the inlet opening via the second passage.

2. The inflow apparatus in accordance with claim 1, wherein the first passage extends continuously from the first outlet opening up to the inlet opening and the second passage extends continuously from the second outlet opening up to the inlet opening.

3. The inflow apparatus in accordance with claim 1, wherein the inflow apparatus has a mixing chamber between the inlet opening and the first outlet opening or the second outlet opening; and the first passage extends continuously from the first outlet opening up to the mixing chamber or the second passage extends continuously from the second outlet opening up to the mixing chamber.

4. The inflow apparatus in accordance with claim 1, wherein the cross-sectional surface of the first passage increases from the inlet opening to the first outlet opening, or the cross-sectional surface of the second passage increases from the inlet opening to the second outlet opening.

5. The inflow apparatus in accordance with claim 1, wherein the first passage opens into the first outlet opening at a predefinable angle or the second passage opens into the second outlet opening at a predefinable angle so that the first passage or the second passage follows a curve.

6. The inflow apparatus in accordance with claim 1, wherein the inflow apparatus includes a fastening element configured to fasten the inflow apparatus in the filling zone.

7. The inflow apparatus in accordance with claim 6, wherein the fastening element is arranged in a region of the inlet opening or at an end opposite the inlet opening.

8. The inflow apparatus in accordance with claim 6, wherein the fastening element is a disk.

9. The inflow apparatus in accordance with claim 6, wherein the fastening element is connected to the first passage or to the second passage via a support element.

10. The inflow apparatus in accordance with claim 1, wherein the first passage or the second passage is at least partly surrounded by a stabilizing element.

11. The inflow apparatus in accordance with claim 10, wherein the first outlet opening or the second outlet opening is integrated in the stabilizing element.

12. The inflow apparatus in accordance with claim 1, wherein the stabilizing element is a lattice.

13. The inflow apparatus in accordance with claim 1, wherein the inflow apparatus is formed by an additive process.

14. A centrifuge drum for a decanter centrifuge having the inflow apparatus of claim 1.

15. A decanter centrifuge having the centrifuge drum of claim 14.

16. A decanter centrifuge having the inflow apparatus of claim 1.
